(19) United States
(12) Patent Application Publication
(10) Pub. No.: US 2025/0016400 A1
(43) Pub. Date: Jan. 9, 2025

(54) LIVESTREAMING PROCESSING METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Xiaonan LIU, Shenzhen (CN); Jianping SHI, Shenzhen (CN); Songsong JIA, Shenzhen (CN); Ermei CAO, Shenzhen (CN); Hailong ZHANG, Shenzhen (CN); Yue MA, Shenzhen (CN); Yue ZHANG, Shenzhen (CN); Jiangbo CAO, Shenzhen (CN)

(21) Appl. No.: 18/892,703

(22) Filed: Sep. 23, 2024

Related U.S. Application Data
(63) Continuation of application No. PCT/CN2023/088346, filed on Apr. 14, 2023.

(30) Foreign Application Priority Data
Nov. 30, 2022 (CN) 202211529530.6

(51) Int. Cl. H04N 21/431; H04N 21/2187; H04N 21/485

(52) U.S. Cl. CPC H04N 21/4316; H04N 21/2187; H04N 21/4858

(57) ABSTRACT

A livestreaming processing method includes: displaying a room interface of a media sharing room, the room interface including a main playing region and a secondary playing region, the secondary playing region including at least one livestreaming window, and each livestreaming window corresponding to a livestreaming object; playing media content in a media playing window in the main playing region, the media content being viewable by at least two objects joining the media sharing room, and the at least two objects including the livestreaming object; and playing, in each the at least one livestreaming window, livestreaming content of at least one livestreaming object corresponding to the at least one livestreaming window in the secondary playing region.

### CROSS-REFERENCES TO RELATED APPLICATIONS

This application is a continuation application of PCT Patent Application No. PCT/CN2023/088346, filed on Apr. 14, 2024, which claims priority to Chinese Patent Application No. 2022115295306, filed on Nov. 30, 2022, both of which are incorporated herein by reference in their entirety.

### FIELD OF THE TECHNOLOGY

The present disclosure relates to the field of Internet technologies, and in particular, to a livestreaming processing method and apparatus, an electronic device, a computer-readable storage medium, and a computer program product.

### BACKGROUND OF THE DISCLOSURE

With the development of the Internet, more users view media content (such as videos) through the Internet. By creating a media sharing room, users joining the media sharing room can be allowed to view media content together. However, the media sharing room often only supports the joined users to view the media content together. A function is undiversified and interactivity between users is poor, resulting in a low participation rate of the users in the media sharing room. Consequently, hardware processing resources for creating and maintaining the media sharing room are wasted, and utilization of the hardware processing resources is reduced.

### SUMMARY

Embodiments of the present disclosure provide a livestreaming processing method and apparatus, an electronic device, a computer-readable storage medium, and a computer program product, which can increase functional diversity and experience diversity of a media sharing room, and improve utilization of hardware processing resources and utilization of device display resources.

Technical solutions in embodiments of the present disclosure are implemented as follows.

An embodiment of the present disclosure provides a livestreaming processing method. The method is performed by an electronic device and includes: displaying a room interface of a media sharing room, the room interface including a main playing region and a secondary playing region, the secondary playing region including at least one livestreaming window, and each livestreaming window corresponding to a livestreaming object; playing media content in a media playing window in the main playing region, the media content being viewable by at least two objects joining the media sharing room, and the at least two objects including the livestreaming object; and playing, in each the at least one livestreaming window, livestreaming content of at least one livestreaming object corresponding to the at least one livestreaming window in the secondary playing region.

An embodiment of the present disclosure further provides a livestreaming processing apparatus, including: a display module, configured to display a room interface of a media sharing room, the room interface including a main playing region and a secondary playing region, the secondary playing region including at least one livestreaming window, and each livestreaming window corresponding to a livestreaming object; a first playing module, configured to play media content in a media playing window in the main playing region, the media content being viewable by at least two objects joining the media sharing room, and the at least two objects including the livestreaming object; and a second playing module, configured to play, in each the at least one livestreaming window, livestreaming content of at least one livestreaming object corresponding to the at least one livestreaming window in the secondary playing region.

An embodiment of the present disclosure further provides an electronic device, including: a memory, configured to store computer-executable instructions; and a processor, configured to implement, when executing the computer-executable instructions stored in the memory, the livestreaming processing method provided in embodiments of the present disclosure.

An embodiment of the present disclosure further provides a non-transitory computer-readable storage medium, having computer-executable instructions stored thereon, the computer-executable instructions, when executed by a processor, implementing the livestreaming processing method provided in embodiments of the present disclosure.

Embodiments of the present disclosure have the following beneficial effects:

According to the foregoing embodiments of the present disclosure, a main playing region and a secondary playing region are displayed on a room interface of a media sharing room, the secondary playing region includes at least one livestreaming window, and each livestreaming window corresponds to a livestreaming object. In addition, media content is played in a media playing window in the main playing region, and livestreaming content of a corresponding livestreaming object is played in each livestreaming window in the secondary playing region. In this case, (1) the media sharing room may be for allowing at least two objects joining the media sharing room to view the media content played in the media playing window. The media sharing room may further for a livestreaming object of the at least two objects to perform livestreaming in the media sharing room. In this way, a user can perform livestreaming or watch livestreaming while viewing the media content, which increases functional diversity and experience diversity of the media sharing room and improves interactivity between users in the media sharing room and user stickiness, thereby fully utilizing hardware processing resources for creating and maintaining the media sharing room and improving utilization of the hardware processing resources. (2) The media content is played in the media playing window in the main playing region, and the livestreaming content of the corresponding livestreaming object is played in the livestreaming window in the secondary playing region, so that display content of each window is properly distributed and a display layout of each window is properly designed, thereby improving utilization of device display resources.

### BRIEF DESCRIPTION OF THE DRAWINGS

FIG. 1 is a schematic diagram of an architecture of a livestreaming processing system 100 according to an embodiment of the present disclosure.

FIG. 2 is a schematic flowchart of a livestreaming processing method according to an embodiment of the present disclosure.

FIG. 3 is a schematic diagram of display of a room interface of a media sharing room according to an embodiment of the present disclosure.

FIG. 4 is a schematic diagram of display of livestreaming processing in a media sharing room according to an embodiment of the present disclosure.

FIG. 5 is a schematic diagram of triggering a position switching instruction according to an embodiment of the present disclosure.

FIG. 6 is a schematic diagram of display of livestreaming processing in a media sharing room according to an embodiment of the present disclosure.

FIG. 7 is a schematic diagram of display of moving a livestreaming window out of a secondary playing region according to an embodiment of the present disclosure.

FIG. 8 is a schematic diagram of display of an object details interface according to an embodiment of the present disclosure.

FIG. 9A is a schematic flowchart of a livestreaming processing method according to an embodiment of the present disclosure.

FIG. 9B is a schematic flowchart of a livestreaming processing method according to an embodiment of the present disclosure.

FIG. 10 is a schematic flowchart of a livestreaming processing method according to an embodiment of the present disclosure.

FIG. 11A is a schematic flowchart of a livestreaming processing method according to an embodiment of the present disclosure.

FIG. 11B is a schematic flowchart of a livestreaming processing method according to an embodiment of the present disclosure.

FIG. 12 is a schematic diagram of synchronizing a livestreaming state according to an embodiment of the present disclosure.

FIG. 13A is a schematic diagram of synchronizing a livestreaming state according to an embodiment of the present disclosure.

FIG. 13B is a schematic diagram of synchronizing a livestreaming state according to an embodiment of the present disclosure.

FIG. 14A is a schematic diagram of a structure of a playing system of media content according to an embodiment of the present disclosure.

FIG. 14B is a schematic diagram of a playing process of media content according to an embodiment of the present disclosure.

FIG. 15A is a schematic diagram of obtaining a livestreaming content stream and a media content stream according to an embodiment of the present disclosure.

FIG. 15B is a schematic diagram of obtaining a livestreaming content stream and a media content stream according to an embodiment of the present disclosure.

FIG. 16 is a schematic diagram of a structure of an electronic device 500 for performing a livestreaming processing method according to an embodiment of the present disclosure.

FIG. 17 is a schematic diagram of a structure of a livestreaming processing apparatus according to an embodiment of the present disclosure.

### DESCRIPTION OF EMBODIMENTS

To make the objectives, technical solutions, and advantages of the present disclosure clearer, the following describes the present disclosure in further detail with reference to the accompanying drawings. The described embodiments are not to be considered as a limitation to the present disclosure. All other embodiments obtained by a person of ordinary skill in the art without creative efforts shall fall within the protection scope of the present disclosure.

In the following description, the term “some embodiments” describes subsets of all possible embodiments, but “some embodiments” may be the same subset or different subsets of all possible embodiments, and can be combined with each other without conflict.

In the following description, the term “first/second/third” is only used for distinguishing similar objects and does not represent a specific order of objects. The term “first/second/third” may be interchanged with a specific order or priority if permitted, so that embodiments of the present disclosure described here may be implemented in an order other than that illustrated or described here.

Unless otherwise defined, meanings of all technical and scientific terms used in this specification are the same as those usually understood by a person skilled in the art to which the present disclosure belongs. Terms used in the specification are merely intended to describe objectives of embodiments of the present disclosure, but are not intended to limit the present disclosure.

Before embodiments of the present disclosure are further described in detail, a description is made on terms in embodiments of the present disclosure, and the terms in embodiments of the present disclosure are applicable to the following explanations.

(1) Client: It is an application running in a terminal for providing various services, such as a media (such as a video and audio) playing client.

(2) “In response to”: It is for representing a condition or a state on which an executed operation relies. If the condition or the state is satisfied, the executed one or more operations may be real-time or have a set delay. There is no limit on an order of execution of the plurality of operations unless otherwise specified.

(3) Media sharing room: It is also referred to as a watch-together room The media sharing room is configured for allowing a plurality of objects joining the media sharing room to view media content played in the media sharing room (such as watching videos and listening to audio). The plurality of objects in the media sharing room include a creating object (that is, a room owner) and a viewing object (that is, a room visitor). The creating object may control a playing progress of the media content and switch the media content being played, and the viewing object may view the played media content synchronously with the creating object.

In embodiments of the present disclosure, the media sharing room is further configured for allowing a livestreaming object of the plurality of objects to perform livestreaming in the media sharing room, so that a non-livestreaming object of the plurality of objects can view livestreaming content of the livestreaming object. In this way, the livestreaming object and the viewing object can view the media content together. Therefore, the media sharing room may also be referred to as a watch-together room. The livestreaming object is also referred to as a livestreamer, corresponding to a livestreaming object end (or referred to as a livestreamer end or a livestreaming end). The livestreaming object may be an object having livestreaming permission in the media sharing room (such as a guest, a celebrity, or a creating object). The non-livestreaming objects is also referred to as a viewer, corresponding to a non-livestreaming object end (or referred to as viewing end).

(4) Media content stream: It is an on-demand content stream used when media content is played in a media playing window in the media sharing room.

(5) Livestreaming content stream: It is a livestreaming stream of the livestreaming object used when livestreaming content of the livestreaming object is played in a livestreaming window in the media sharing room.

(6) Video on demand (VOD) relates to a system that allows a user to select media content the user wants to watch through the Internet. After the user selects the media content, the video on demand system may play the media content instantly in the form of streaming media, or the media content may be completely downloaded before being played. The user can freely control a playing progress, playing resolution, playing speed, and the like of the media content. The media content in embodiments of the present disclosure is on-demand content played in a video on demand manner.

(7) Livestreaming relates to a system in which a radio station, a television station, an online platform, and other media play livestreaming content in a live and instant manner. The livestreaming content is a thing that is happening somewhere at this moment, and the viewer cannot control a playing progress of the livestreaming content.

Embodiments of the present disclosure provide a livestreaming processing method and apparatus, an electronic device, a computer-readable storage medium, and a computer program product, which can increase functional diversity and experience diversity of a media sharing room, and improve utilization of hardware processing resources and utilization of device display resources. Detailed descriptions are separately provided below.

In embodiments of the present disclosure, related data such as user information and user data needs to be obtained and processed after user's authorization and consent. When embodiments of the present disclosure are applied to specific products or technologies, user permission or consent needs to be obtained, and collection, use, and processing of related data need to comply with relevant laws, regulations, and standards of relevant countries and regions.

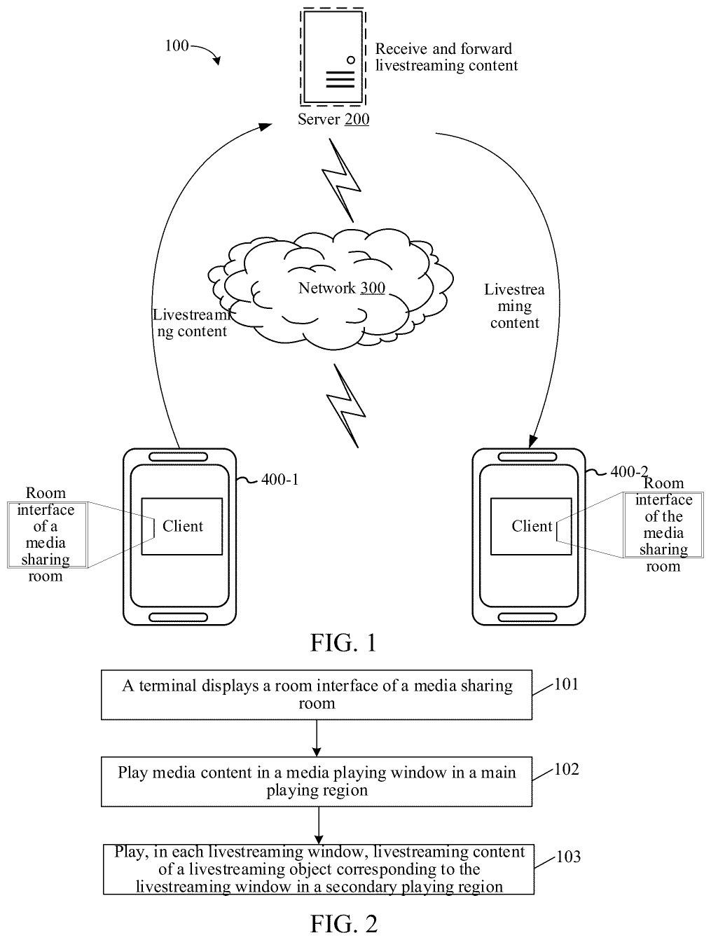

Based on the foregoing explanation of terms involved in embodiments of the present disclosure, the following describes a livestreaming processing system provided in an embodiment of the present disclosure. FIG. 1 is a schematic diagram of an architecture of a livestreaming processing system 100 according to an embodiment of the present disclosure. To support one exemplary application, a terminal 400-1 (corresponding to a livestreaming object) and a terminal 400-2 (corresponding to a non-livestreaming object) are connected to a server 200 via a network 300. The network 300 may be a wide area network or a local area network, or a combination thereof. Data transmission may be implemented by using a wireless or wired link.

The terminal 400-1 is configured to obtain livestreaming content of the livestreaming object and transmit the livestreaming content of the livestreaming object to the server 200, so that the server 200 synchronizes the livestreaming content to the terminal 400-2.

The server 200 is configured to receive the livestreaming content of the livestreaming object transmitted by the terminal 400-1.

The terminal 400-2 is configured to: display a room interface of a media sharing room, the room interface including a main playing region and a secondary playing region, the secondary playing region including at least one livestreaming window, and each livestreaming window corresponding to a livestreaming object; and transmit a content obtaining request to the server 200. The content obtaining request is configured for obtaining media content to be played in the media sharing room and livestreaming content of each livestreaming object. The media content is viewable by at least two objects joining the media sharing room, and the at least two objects include the livestreaming object.

The server 200 is configured to: receive the content obtaining request transmitted by the terminal 400-2; and transmit the media content and the livestreaming content of the livestreaming object to the terminal 400-2 in response to the content obtaining request.

The terminal 400-2 is further configured to: receive the media content and the livestreaming content of the livestreaming object transmitted by the server 200; play the media content in a media playing window in the main playing region; and play, in each the at least one livestreaming window, livestreaming content of at least one livestreaming object corresponding to the at least one livestreaming window in the secondary playing region.

In some embodiments, the livestreaming processing method provided in this embodiment of the present disclosure may be performed by various electronic devices. For example, the method may be performed by a terminal independently, by a server independently, or by a terminal and a server collaboratively. The livestreaming processing method provided in this embodiment of the present disclosure may be applied to various scenarios, including but not limited to a cloud technology, artificial intelligence, smart transportation, audio and video, driver assistance, and the like.

In some embodiments, the electronic device that performs the livestreaming processing provided in this embodiment of the present disclosure may be various types of terminal or servers. The server (such as the server 200) may be an independent physical server, or may be a server cluster or a distributed system including a plurality of physical servers. The terminal (such as the terminal 400-1) may be a smartphone, a tablet, a laptop, a desktop computer, an intelligent voice interaction device (such as a smart speaker), a smart home appliance (such as a smart TV), a smartwatch, an on-board terminal, and the like, but is not limited thereto. The terminal is directly or indirectly connected to the server via a wired or wireless communication manner. This is not limited in this embodiment of the present disclosure.

In some embodiments, the livestreaming processing method provided in this embodiment of the present disclosure may be implemented with the help of a cloud technology. The cloud technology refers to a hosting technology that integrates resources, such as hardware, software, and a network in a wide area network or a local area network, to implement data computing, storage, processing, and sharing. A cloud computing technology is to be the backbone. A large amount of computing resources and storage resources are needed for background services in a technical network system. As an example, the server (such as the server 200) may alternatively be a cloud server providing basic cloud computing services, such as a cloud service, a cloud database, cloud computing, a cloud function, cloud storage, a network service, a cloud communication, a middleware service, a domain name service, a security service, a content delivery network (CDN), and a big data and artificial intelligence platform.

In some embodiments, a plurality of servers may form a blockchain, and the servers are nodes on the blockchain. Information connections between the nodes may exist in the blockchain, and information may be transmitted between nodes through the foregoing information connections. Data related to the livestreaming processing method provided in this embodiment of the present disclosure (such as room information, the media content, and the livestreaming content of the media sharing room) can be stored on the blockchain.

In some embodiments, the terminal or the server can implement the livestreaming processing method provided in this embodiment of the present disclosure by running a computer program. For example, the computer program may be a native and executable software module in an operating system; may be a native application (APP), that is, a program that needs to be installed in the operating system to run, such as an audio and video client; or may be a mini program that can be embedded in any APP, that is, a program that only needs to be downloaded into a browser environment to run. In conclusion, the foregoing computer program may be any form of application program, module, or plug-in.

The following describes the livestreaming processing method provided in this embodiment of the present disclosure. In some embodiments, the livestreaming processing method provided in this embodiment of the present disclosure may be performed by various electronic devices. For example, the method may be performed by a terminal independently, by a server independently, or by a terminal and a server collaboratively. An example in which the method is performed by a terminal is used. FIG. 2 is a schematic flowchart of a livestreaming processing method according to an embodiment of the present disclosure. The livestreaming processing method provided in this embodiment of the present disclosure includes the following.

Operation 101: The terminal displays a room interface of a media sharing room.

The room interface includes a main playing region and a secondary playing region. The secondary playing region includes at least one livestreaming window. Each livestreaming window corresponds to a livestreaming object.

The media sharing room is configured for allowing at least two objects joining the media sharing room to view media content played in a media playing window of the main playing region. The at least two objects include each livestreaming object. The media sharing room is further configured for allowing each livestreaming object to perform livestreaming in the media sharing room, so that a non-livestreaming object of the at least two objects can view corresponding livestreaming content.

In operation 101, the terminal may correspond to a viewing object (that is, a user) of the at least two objects. The viewing object may be the livestreaming object in the media sharing room or the non-livestreaming object in the media sharing room. In actual application, the user may join the media sharing room through a terminal held by the user, and the server may communicate with the terminal to provide related services for the media sharing room on the terminal, so that the user can view the media content played in the media sharing room. The terminal may be provided with a client, and the client may be a client supporting a function of the media sharing room, such as a video client supporting the function of the media sharing room, an audio client supporting the function of the media sharing room, or an instant messaging client supporting the function of the media sharing room.

In operation 101, the user operates the terminal held by the user to enter the media sharing room, and the terminal displays the room interface of the media sharing room. The user mentioned in this embodiment of the present disclosure may be an object corresponding to an account of the client that is currently logged in, or may be an object using a current client when the client is not currently logged in.

In some embodiments, the terminal may display the room interface of the media sharing room in the following manner: controlling the terminal to be in a vertical screen operation mode when a vertical screen operation instruction for the terminal is received, and using a first layout style, in the vertical screen operation mode, to display the room interface of the media sharing room; or controlling the terminal to be in a horizontal screen operation mode when a horizontal screen operation instruction for the terminal is received, and using a second layout style, in the horizontal screen operation mode, to display the room interface of the media sharing room. A position of a window in the room interface in the first layout style is different from that in the second layout style, and the window includes the media playing window and the livestreaming window.

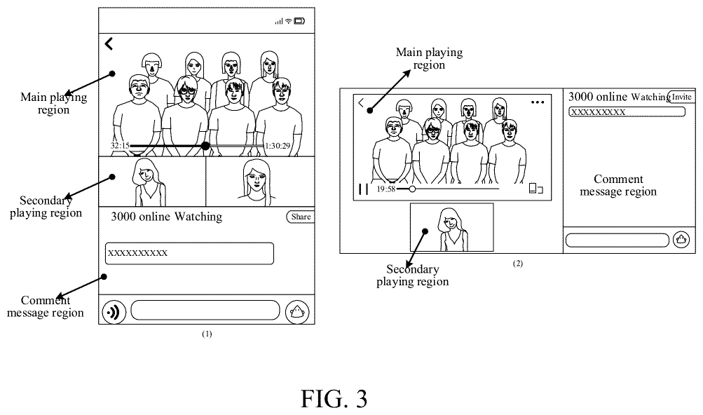

Different layout styles are provided for the vertical screen operation mode and the horizontal screen operation mode. FIG. 3 is a schematic diagram of display of a room interface of a media sharing room according to an embodiment of the present disclosure. As shown in section (1) of FIG. 3, in the vertical screen operation mode, a room interface is displayed by using the first layout style, including the main playing region, the secondary playing region, and a comment message region from top to bottom in sequence. As shown in section (2) of FIG. 3, in the horizontal screen operation mode, a room interface is displayed by using the second layout style, including the main playing region and the secondary playing region from top to bottom at the left part of the figure, and a comment message region at the right part of the figure. The secondary playing region includes a plurality of livestreaming windows, and each livestreaming window corresponds to a livestreaming object. In this way, in the vertical screen operation mode and the horizontal screen operation mode, the room interface is displayed in different layout styles, and display layouts in the vertical screen operation mode and the horizontal screen operation mode are properly designed, thereby improving a device display effect and utilization of device display resources.

In some embodiments, a position of any livestreaming window and a position of the media playing window may be switched. To be specific, a position of a livestreaming window in the secondary playing region and the position of the media playing window in the main playing region may be switched. In actual application, positions of the livestreaming windows in the secondary playing region may also be switched. In this way, the user may control position switching between the livestreaming window and the media playing window as needed, increasing interactive activities between users and improving user experience.

The main playing region and the secondary playing region mentioned in this embodiment of the present disclosure are only used for naming and there is no distinction between primary and secondary.

Operation 102: Play the media content in the media playing window in the main playing region.

The media content is configured for allowing the at least two objects joining the media sharing room to view, and the at least two objects include the livestreaming object.

Operation 103: Play, in each the at least one livestreaming window, livestreaming content of at least one livestreaming object corresponding to the at least one livestreaming window in the secondary playing region.

Still refer to FIG. 3. The media content is played in the media playing window in the main playing region, and the livestreaming content of the livestreaming object corresponding to the livestreaming window is played in the livestreaming window in the secondary playing region.

In some embodiments, the terminal may play the media content in the media playing window in the following manner: obtaining a media content stream, and playing the media content in the media playing window based on the media content stream. Correspondingly, the terminal may play the livestreaming content of the livestreaming object corresponding to the livestreaming window in the livestreaming window in the following manner: obtaining a livestreaming content stream that is of each livestreaming object and that is independent of the media content stream, the livestreaming content streams being independent of each other; and playing, in respect of each livestreaming window, in the livestreaming window based on a livestreaming content stream of a livestreaming object corresponding to the livestreaming window, livestreaming content of the livestreaming object corresponding to the livestreaming window. The media content is played based on the media content stream, and livestreaming content of each livestreaming window is played based on a corresponding livestreaming content stream. In this embodiment of the present disclosure, when the media content stream and the livestreaming content stream are obtained, the independent media content stream and the independent livestreaming content stream are obtained separately, and the content streams are not undergone stream mix. In this way, the media content stream and the livestreaming content stream are independent. In terms of quality and resolution of an image, resolution of the media content stream can be maintained, and the position of the livestreaming window and the position of the media playing window can be switched. Livestreaming content streams are also independent and played in their own corresponding livestreaming window. A position of each livestreaming window and the position of the media playing window may be switched separately, and the livestreaming window may be zoomed in, zoomed out, moved, or the like individually. In this way, flexibility of a livestreaming window layout is increased.

In some embodiments, the terminal may implement the position switching between the media playing window and the livestreaming window in the following manner: switching, in response to a position switching instruction for a target livestreaming window of the at least one livestreaming window, a position of the media playing window and a position of the target livestreaming window; and playing, in the target livestreaming window, livestreaming content of a livestreaming object corresponding to the target livestreaming window in the main playing region, and playing the media content in the media playing window in the secondary playing region. When the terminal receives the position switching instruction for the target livestreaming window of the at least one livestreaming window, the terminal may control switching the position of the media playing window and the position of the target livestreaming window. In this way, the livestreaming content can be played in the target livestreaming window in the main playing region, and the media content can be played in the media playing window in the secondary playing region. In actual implementation, a region size of the main playing region is larger than a window size of each livestreaming window. Therefore, a position of the media playing window and a position of the target livestreaming window are switched, so that playing can also be performed in the livestreaming window in the main playing region having a larger region size. If the user is more concerned about the livestreaming content of the livestreaming object, the demand can be met through the position switching, thereby improving a user's viewing effect in the media sharing room.

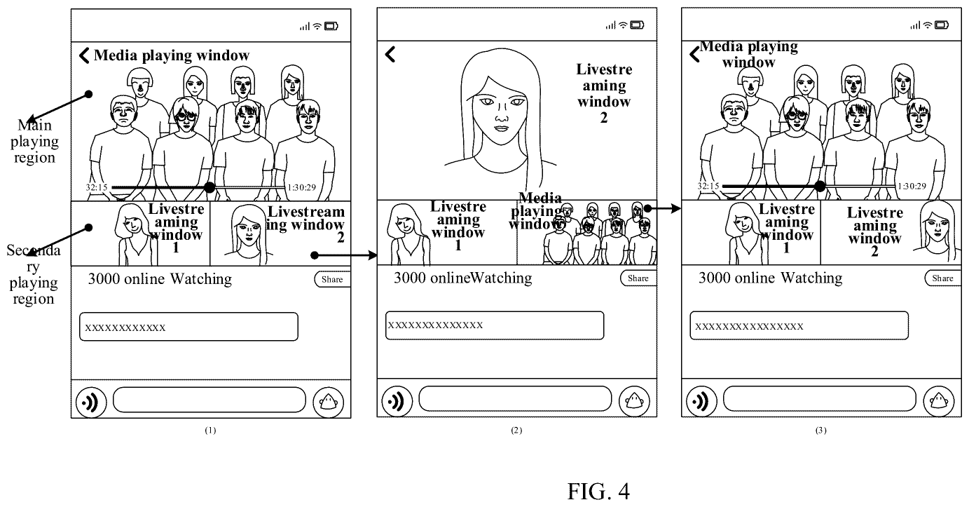

For example, FIG. 4 is a schematic diagram of display of livestreaming processing in a media sharing room according to an embodiment of the present disclosure. As shown in FIG. 4 (1), a room interface of the media sharing room is displayed, and a main playing region and a secondary playing region are displayed in the room interface. Media content is played in a media playing window in the main playing region, and livestreaming content of a corresponding livestreaming object is played in each livestreaming window in the secondary playing region. As shown in section (2) of FIG. 4, the position of the media playing window and a position of a “livestreaming window 2” are switched in response to a position switching instruction for the “livestreaming window 2”, so that livestreaming content is played in the “livestreaming window 2” in the main playing region, and the media content is played in the media playing window in the secondary playing region.

The trigger operation mentioned in this embodiment of the present disclosure may be any operation that can trigger a corresponding function, such as a single-tap/click operation, a double-tap/click operation, a hold/long press operation, and a drag operation. The control mentioned in this embodiment of the present disclosure may be equivalent to a function item and may have various presentation forms, such as a graphic button, a progress bar, a menu, and a list. This is not limited in this embodiment of the present disclosure.

In some embodiments, the terminal may receive the position switching instruction in the following manner: receiving a trigger operation on the target livestreaming window of the at least one livestreaming window; and receiving the position switching instruction for the target livestreaming window of the at least one livestreaming window in response to the trigger operation. The position switching instruction may be triggered by triggering the trigger operation such as a tap/click operation, a double-tap/click operation, or a hold/long press operation on the target livestreaming window.

In some embodiments, the terminal may receive the position switching instruction in the following manner: displaying, in response to a trigger operation on the target livestreaming window of the at least one livestreaming window, a position switching control corresponding to the target livestreaming window; and receiving the position switching instruction for the target livestreaming window of the at least one livestreaming window in response to a trigger operation on the position switching control. A corresponding position switching control may also be provided for the target livestreaming window, so that the user can trigger the position switching instruction based on the position switching control.

In some embodiments, the terminal may receive the position switching instruction in the following manner: receiving a drag operation on the target livestreaming window of the at least one livestreaming window; and receiving the position switching instruction for the target livestreaming window of the at least one livestreaming window in response to the target livestreaming window being dragged to the main playing region. The position switching instruction may alternatively be triggered by dragging the target livestreaming window to the main playing region. When an overlapping portion between the target livestreaming window and the main playing region reaches an overlapping threshold, the target livestreaming window is dragged to the main playing region, and the overlapping threshold may be preset.

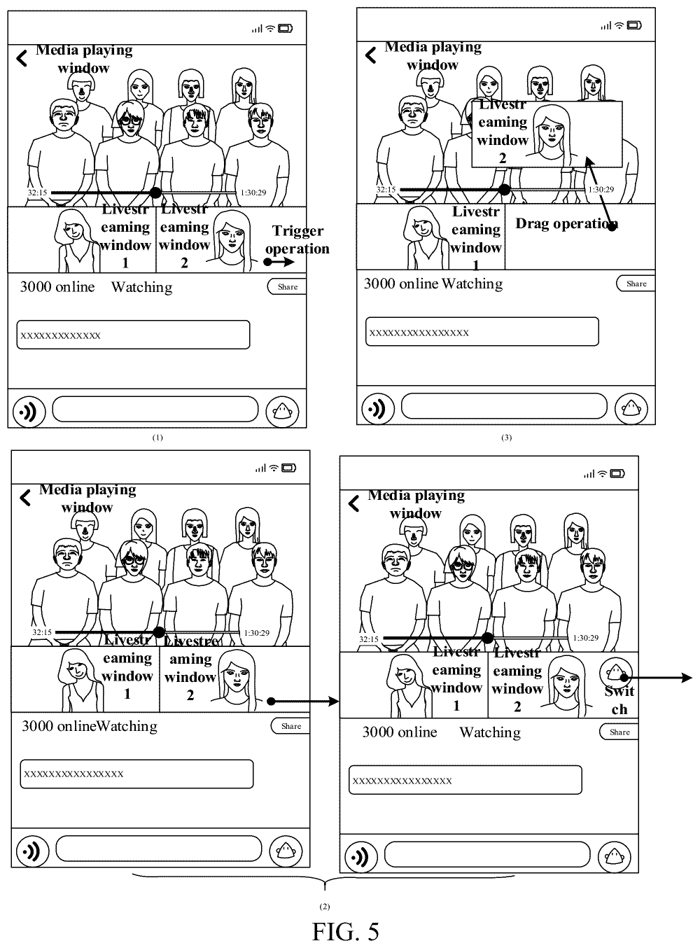

For example, FIG. 5 is a schematic diagram of triggering a position switching instruction according to an embodiment of the present disclosure. As shown in section (1) of FIG. 5, the position switching instruction for the target livestreaming window is received in response to the trigger operation (such as a hold/long press operation or a tap/click operation) on the target livestreaming window. As shown in section (2) of FIG. 5, a position switching control “Switch” is displayed in response to the trigger operation on the target livestreaming window, and the position switching instruction for the target livestreaming window is received in response to the trigger operation on the position switching control. As shown in section (3) of FIG. 5, the position switching instruction for the target livestreaming window is received in response to the target livestreaming window being dragged to the main playing region.

According to the foregoing embodiment, the position switching instruction for the target livestreaming window can be triggered by the trigger operation on the target livestreaming window, the trigger operation on the position switching control, dragging the target livestreaming window to the main playing region, and another operation, enriching implementations of the position switching and improving user's interaction experience.

In some embodiments, the secondary playing region includes at least one sub-playing region, the at least one livestreaming window is in one-to-one correspondence with the at least one sub-playing region, and a region size of the main playing region is larger than a region size of the sub-playing region. After switching the position of the media playing window and the position of the target livestreaming window, the terminal may further perform the following processing: adjusting a window size of the media playing window, so that the window size of the media playing window matches a region size of a sub-playing region corresponding to the target livestreaming window; and adjusting a window size of the target livestreaming window, so that the window size of the target livestreaming window matches the region size of the main playing region. Because the region size of the main playing region is larger than the region size of the sub-playing region, after the position of the media playing window and the position of the target livestreaming window are switched, the window size of the media playing window is also needs to be adjusted, so that the window size of the media playing window matches the region size of the sub-playing region corresponding to the target livestreaming window; and the window size of the target livestreaming window is also needs to be adjusted, so that the window size of the target livestreaming window matches the region size of the main playing region. In this way, playing can also be performed in the livestreaming window in the main playing region having the larger region size. If the user is more concerned about the livestreaming content of the livestreaming object, the demand can be met through the position switching, thereby improving a user's livestreaming viewing effect in the media sharing room.

The size herein is configured for indicating an area occupied by a corresponding window or region. For example, the region size of the main playing region indicates an area occupied by the main playing region. For another example, the window size of the media playing window indicates an area occupied by the media playing window. The window in this embodiment of the present disclosure is a general term of the media playing window and the livestreaming window.

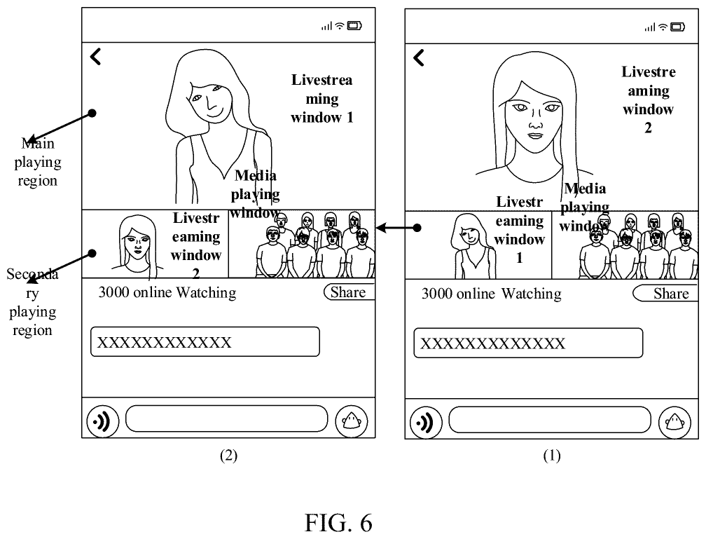

In some embodiments, the terminal may switch a position of a first livestreaming window in the secondary playing region and the position of the target livestreaming window in the main playing region in the following manner: receiving a first position switching instruction for the first livestreaming window, the first livestreaming window being a livestreaming window of the at least one livestreaming window that is different from the target livestreaming window; switching the position of the target livestreaming window and the position of the first livestreaming window in response to the first position switching instruction; playing, in the first livestreaming window, livestreaming content of a livestreaming object corresponding to the first livestreaming window in the main playing region; and playing, in the target livestreaming window, the livestreaming content of the livestreaming object corresponding to the target livestreaming window in the secondary playing region. For example, FIG. 6 is a schematic diagram of display of livestreaming processing in a media sharing room according to an embodiment of the present disclosure. As shown in section (1) of FIG. 6, livestreaming content is played in a “livestreaming window 2” in the main playing region, and the media content is played in the media playing window in the secondary playing region. As shown in section (2) of FIG. 6, a position of the “livestreaming window 2” and a position of a “livestreaming window 1” are switched in response to the first position switching instruction for the “livestreaming window 1”, so that livestreaming content of a livestreaming object corresponding to the “livestreaming window 1” is played in “livestreaming window 1” in the main playing region, and livestreaming content of a livestreaming object corresponding to the “livestreaming window 2” is played in “livestreaming window 2” in the secondary playing region.

In actual implementation, the secondary playing region includes at least one sub-playing region, and the at least one livestreaming window is in one-to-one correspondence with the at least one sub-playing region. Because the region size of the main playing region is larger than the region size of the sub-playing region, after the terminal switches the position of the target livestreaming window and the position of the first livestreaming window, the window size of the target livestreaming window also needs to be adjusted, so that the window size of the target livestreaming window matches a region size of a sub-playing region corresponding to the first livestreaming window; and a window size of the first livestreaming window also needs to be adjusted, so that the window size of the first livestreaming window matches the region size of the main playing region. In this way, the window after the position switching can better match a corresponding playing region, thereby improving a viewing effect of the media content and the livestreaming content.

In some embodiments, the terminal may switch the position of the media playing window and the position of the target livestreaming window again in the following manner: switching the position of the target livestreaming window and the position of the media playing window in response to a second position switching instruction for the media playing window; playing again the media content in the media playing window in the main playing region; and playing again, in the target livestreaming window, the livestreaming content of the livestreaming object corresponding to the target livestreaming window in the secondary playing region. For an example, still refer to FIG. 4. As shown in section (3) in FIG. 4, the position of the target livestreaming window and the position of the media playing window is switched in response to the second position switching instruction for the media playing window, so that the media content is played again in the media playing window in the main playing region, and the livestreaming content of the livestreaming object corresponding to the target livestreaming window is played again in the target livestreaming window in the secondary playing region.

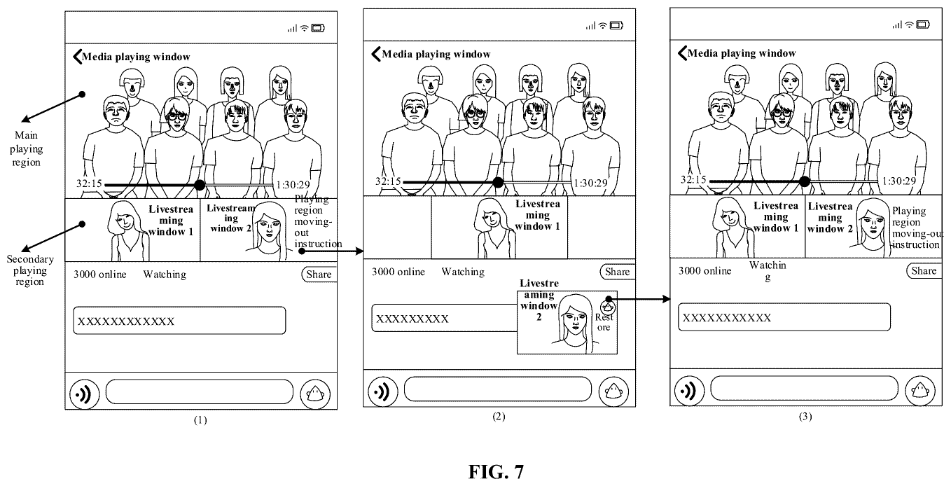

In some embodiments, the terminal may further control the livestreaming window to be moved out of the secondary playing region in the following manner: receiving a playing region moving-out instruction for a second livestreaming window, the second livestreaming window being a livestreaming window of the at least one livestreaming window that is different from the target livestreaming window; and moving the second livestreaming window out of the secondary playing region in response to the playing region moving-out instruction and controlling the second livestreaming window to be in a floating state to float on the room interface. The livestreaming window in the secondary playing region may also be moved out of the secondary playing region. The playing region moving-out instruction may be triggered by a trigger manner such as a hold/long press operation, a double-tapping/click operation, or a dragging operation, or may be triggered by a preset control. In actual application, after the second livestreaming window is moved out of the secondary playing region, a window size of a remaining window in the secondary playing region may be further adjusted to enable a total window size of the remaining window to match the region size of the secondary playing region. For example, FIG. 7 is a schematic diagram of display of moving a livestreaming window out of a secondary playing region according to an embodiment of the present disclosure. As shown in section (1) of FIG. 7, a “livestreaming window 2” is displayed in the secondary playing region. As shown in section (2) of FIG. 7, the “livestreaming window 2” is moved out of the secondary playing region in response to the playing region moving-out instruction for the “livestreaming window 2”, and the “livestreaming window 2” is controlled to be in a floating state to float on the room interface.

In some embodiments, after controlling the second livestreaming window to be in the floating state, the terminal may also control movement and the window size of the livestreaming window in the following manner: moving, when a moving instruction for the second livestreaming window is received, the second livestreaming window in the floating state to a position indicated by the moving instruction; and adjusting, when a window size adjustment instruction for the second livestreaming window is received, a window size of the second livestreaming window in the floating state to a target window size indicated by the window size adjustment instruction. For the second livestreaming window in the floating state, a floating position of the second livestreaming window in the room interface may be moved as needed, and the window size of the second livestreaming window may also be adjusted as needed.

In some embodiments, the terminal may also display a window restore control, and control the second livestreaming window to exit the floating state and move to the secondary playing region in response to a trigger operation on the window restore control. The window restore control is configured to enable the second livestreaming window in the floating state to exit the floating state and move the second livestreaming window to the secondary playing region. The window restore control may be displayed in the room interface, the second livestreaming window, the secondary playing region, or the like. Still refer to FIG. 7. As shown in section (2) of FIG. 7, the window restore control is displayed in the livestreaming window 2. The second livestreaming window is controlled to exit the floating state and move to the secondary playing region in response to the trigger operation on the window restore control “Restore”, as shown in section (3) of FIG. 7.

According to the foregoing embodiment, the livestreaming window can be displayed in the floating state on the room interface independently of the playing region. The user can not only move the livestreaming window to any position in the room interface, but also adjust the size of the livestreaming window, thereby improving interactivity of the livestreaming window. The user can adjust the position and the size of the livestreaming window as needed, thereby improving user experience. When the livestreaming window is in the floating state, the user may also use the window restore control to control the livestreaming window to exit the floating state. In this way, the livestreaming window is controlled to be switched freely between the floating state and a non-floating state.

In some embodiments, the terminal further provides a window hiding control in the secondary playing region. For a plurality of windows in the secondary playing region, the user may further select a window the user wants to hide for hiding. Specifically, a window hiding control is displayed in the secondary playing region. A selection control corresponding to each window in the secondary playing region is displayed in response to a trigger operation on the window hiding control, and the window is a general term of the media playing window and the livestreaming window. A target window in the secondary playing region is hidden in response to a trigger operation on a selection control corresponding to the target window of the windows. In view of this, after hiding the target window in the secondary playing region, the terminal may further adjust a window size of a remaining window in the secondary playing region, so that the window size of the remaining window matches a region size of the secondary playing region. The remaining window is a window of the windows except the target window. In addition, when the selection control is triggered again, the target window may also be displayed again. In this way, the user can control display of a window to be displayed as needed, so that utilization of device display resources can be improved.

In some embodiments, the terminal may display a comment message window in a region that is in the room interface and that is independent of the main playing region and the secondary playing region, and display at least one comment message in the media sharing room in the comment message window; and display, when a trigger operation on a target comment message of the at least one comment message is received, an object details interface of a target object transmitting the target comment message. In some embodiments, the terminal may display a livestreaming invitation control in the object details interface; and transmit a livestreaming invitation request to a terminal of the target object in response to a trigger operation on the livestreaming invitation control, the livestreaming invitation request being configured for inviting the target object to perform livestreaming in the media sharing room.

When the user views the target comment message of interest in the comment message window, the user may view, by triggering the trigger operation on the target comment message, detailed information of the target object transmitting the target comment message. In this case, the terminal displays, in response to the trigger operation on the target comment message, the object details interface of the target object transmitting the target comment message, to display object details of the target object in the object details interface, such as an object identifier, an object avatar, and an object label of the target object. In addition, in this embodiment of the present disclosure, the livestreaming invitation control may be further displayed, and the user may use the livestreaming invitation control to invite the target object to perform livestreaming in the media sharing room, so as to facilitate interacting with the target object during livestreaming. In this way, interactivity between users in the media sharing room is improved, thereby increasing functional diversity and experience diversity of the media sharing room.

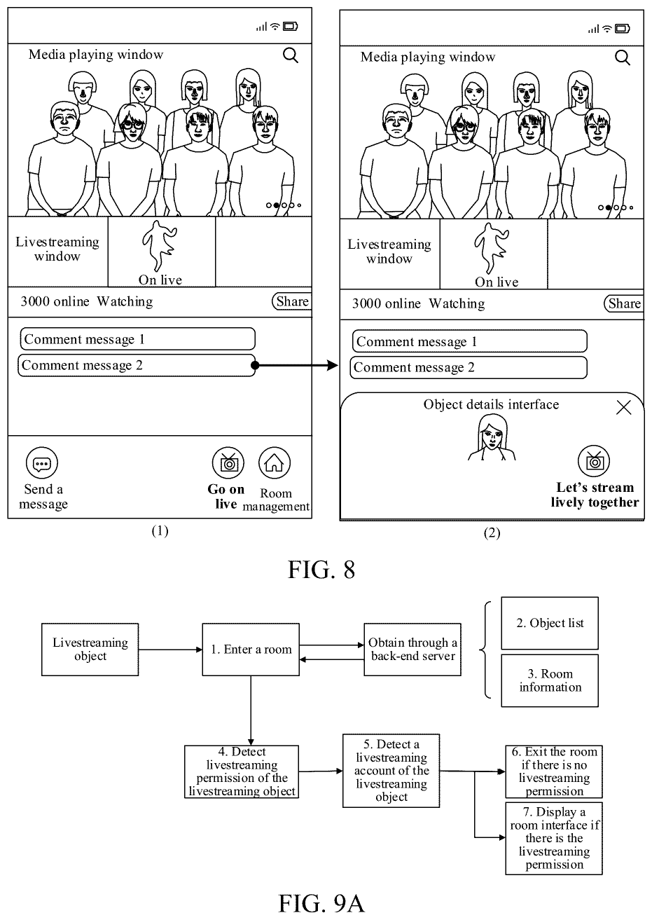

As example, FIG. 8 is a schematic diagram of display of an object details interface according to an embodiment of the present disclosure. The comment message window is displayed in the room interface, and the at least one comment message in the media sharing room is displayed in the comment message window, that are, a comment message 1 and a comment message 2 shown in section (1) in FIG. 8. An object details interface of a target object transmitting the “comment message 2” is displayed in response to a trigger operation on the “comment message 2”, and object details of the target object is displayed in the object details interface, such as an object identifier, an object avatar, and an object label of the target object. A livestreaming invitation control “Let's stream lively together” is displayed simultaneously, as shown in section (2) in FIG. 8.

According to the foregoing embodiments of the present disclosure, a main playing region and a secondary playing region are displayed on a room interface of a media sharing room, the secondary playing region includes at least one livestreaming window, and each livestreaming window corresponds to a livestreaming object. In addition, media content is played in a media playing window in the main playing region, and livestreaming content of a corresponding livestreaming object is played in each livestreaming window in the secondary playing region. In this case, (1) the media sharing room may be for allowing at least two objects joining the media sharing room to view the media content played in the media playing window. The media sharing room may further for a livestreaming object of the at least two objects to perform livestreaming in the media sharing room. In this way, a user can perform livestreaming or watch livestreaming while viewing the media content, which increases functional diversity and experience diversity of the media sharing room and improves interactivity between users in the media sharing room and user stickiness, thereby fully utilizing hardware processing resources for creating and maintaining the media sharing room and improving utilization of the hardware processing resources. (2) The media content is played in the media playing window in the main playing region, and the livestreaming content of the corresponding livestreaming object is played in the livestreaming window in the secondary playing region, so that display content of each window is properly distributed and a display layout of each window is properly designed, thereby improving utilization of device display resources.

Exemplary application of this embodiment of the present disclosure in a practical application scenario is described below.

In related art, a played media content stream and livestreaming content stream are usually mixed into one content stream, and the one content stream is played in one playing region. However, there are the following problems: (1) Quality and resolution of an image is degraded. Quality and resolution of an image of on-demand content (that is, media content) is degraded during stream mix. (2) Client flexibility is poor. Because the media content stream and the livestreaming content stream belong to one single content stream, a viewer cannot customize a watch-together layout. (3) Interactive experience is poor. In a scenario in which a plurality of livestreamers start livestreaming, all livestreaming content streams are mixed together, and therefore, an operation cannot be performed on a livestreaming screen of a single livestreaming object separately.

In view of this, this embodiment of the present disclosure provides a livestreaming processing method to at least resolve the foregoing existing problems. The livestreaming processing method provided in embodiments of the present disclosure is first described from a product level, and includes the following: (1) A livestreaming end performs preparation. Before a livestreaming object starts livestreaming, it is necessary to determine whether the livestreaming object has livestreaming permission to perform livestreaming in a media sharing room. If the livestreaming object has the livestreaming permission to perform livestreaming in the media sharing room, the livestreaming object may be allowed to perform livestreaming. If the livestreaming object does not have the livestreaming permission to perform livestreaming in the media sharing room, the livestreaming object may be prompted to request for the livestreaming permission performing livestreaming in the media sharing room, and perform livestreaming after the application is approved.

(2) Livestreaming is performed at the livestreaming end. After creating a media sharing room, the livestreaming object having the livestreaming permission may perform livestreaming by using a livestreaming control displayed in a room interface. When the livestreaming object starts livestreaming, a terminal guides the livestreaming object to set a livestreaming starting lens. When the livestreaming object chooses video livestreaming, the livestreaming object is to be prompted to enable camera permission. When the livestreaming object chooses voice livestreaming, the livestreaming object is to be prompted to enable microphone permission. The livestreaming object may further set various lens effects such as beautification and a filter in a livestreaming preparation interface. After setting the lens effects, the livestreaming object taps/clicks a livestreaming starting control, the terminal may display a three-second countdown animation effect. In addition, after the animation effect display ends, livestreaming starts now, and a non-livestreaming object (that is, a viewer) can view livestreaming content of the livestreaming object at this time.

(3) A non-livestreaming object end views the livestreaming content of the livestreaming object. After the non-livestreaming object enters the media sharing room, the terminal displays different livestreaming content based on an object state of the livestreaming object, and displays the object state of the livestreaming object. The object state includes one of the following: a state of not entering the media sharing room, a livestreaming ready state, a voice livestreaming state, a video livestreaming state, a livestreaming end state, and a state of leaving the media sharing room. The non-livestreaming object may further switch a position of a media playing window and a position of a livestreaming window to play the livestreaming content in a main playing region and the media content in a secondary playing region, to meet a requirement of the user who wants to view the livestreaming content of a specific livestreaming object in the main playing region. The room interface of the media sharing room may be displayed in a vertical screen operation mode or a horizontal screen operation mode. Specifically, as shown in section (1) of FIG. 3, in the vertical screen operation mode, a room interface is displayed by using the first layout style, including the main playing region, the secondary playing region, and a comment message region from top to bottom in sequence. As shown in section (2) of FIG. 3, in the horizontal screen operation mode, a room interface is displayed by using the second layout style, including the main playing region and the secondary playing region from top to bottom at the left part of the figure, and a comment message region at the right part of the figure. The secondary playing region includes a plurality of livestreaming windows, and each livestreaming window corresponds to a livestreaming object.

The livestreaming processing method provided in embodiments of the present disclosure is described from an algorithm level, and includes the following.

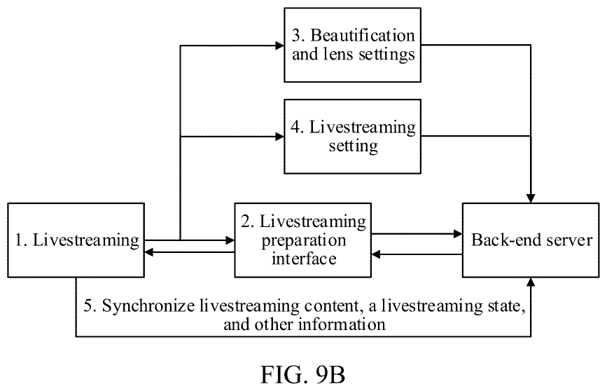

(1) A livestreaming object starts livestreaming. FIG. 9A is a schematic flowchart of a livestreaming processing method according to an embodiment of the present disclosure. The method includes the following: 1. The livestreaming object enters a media sharing room. 2. Obtain a list of livestreaming objects having livestreaming permission via a back-end server of the media sharing room. 3. Obtain media sharing room information via a server of the media sharing room. 4. Detect livestreaming permission of the livestreaming object. 5. Detect a livestreaming account of the livestreaming object. 6. Exit the room if there is no the livestreaming permission. 7. Display the room interface if there is the livestreaming permission. FIG. 9B is a schematic flowchart of a livestreaming processing method according to an embodiment of the present disclosure. The method includes the following: 1. A livestreaming object performs livestreaming. 2. Display a livestreaming preparation interface. 3. Set beautification and lens. 4. Set livestreaming. 5. Synchronize livestreaming content, a livestreaming state, and other information to the back-end server.

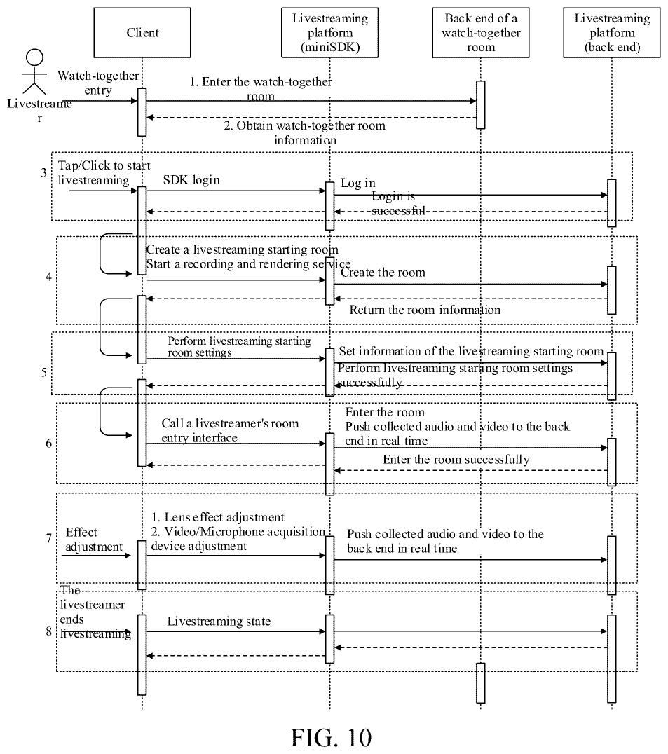

For a detailed process, refer to FIG. 10. FIG. 10 is a schematic flowchart of a livestreaming processing method according to an embodiment of the present disclosure. The method includes the following: 1. A livestreamer enters a watch-together room. 2. A client obtains room information, livestreamer information, and a list of livestreamers having livestreaming permission. 3. Login before starting livestreaming: The client logs in to a livestreamer's livestreaming account by logging into a software development kit (SDK), and livestreaming is started after successful login. 4. Prepare for starting livestreaming: The client creates a livestreaming starting room in a back end of a livestreaming platform through a livestreaming platform, and starts a recording and rendering service simultaneously. 5. Settings for starting livestreaming: The client sets a livestreaming starting room, including whether to enable beautification in the livestreaming starting room, whether to start the camera, whether to turn on a filter, and the like, and synchronizes configured information of the livestreaming starting room to the back end of the livestreaming platform. 6. The client calls a livestreamer's room entry interface for entering the watch-together room, and during the livestreamer's livestreaming, collected audio and video is pushed to the back end of the livestreaming platform in real time. 7. Effect adjustment: During the livestreamer's livestreaming, lens effects (including beautification, filters, lens flip, resolution, and the like) and a video/microphone acquisition device may be adjusted, and the like. 8. The livestreamer ends livestreaming. After the livestreamer ends the livestreaming, the client reports a livestreaming state “Livestreaming ends” to the back end of the livestreaming platform.

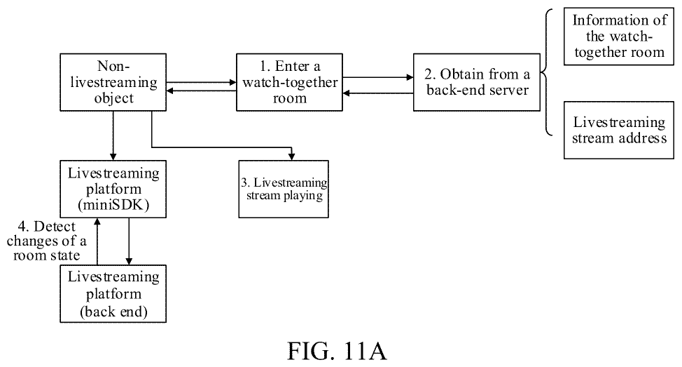

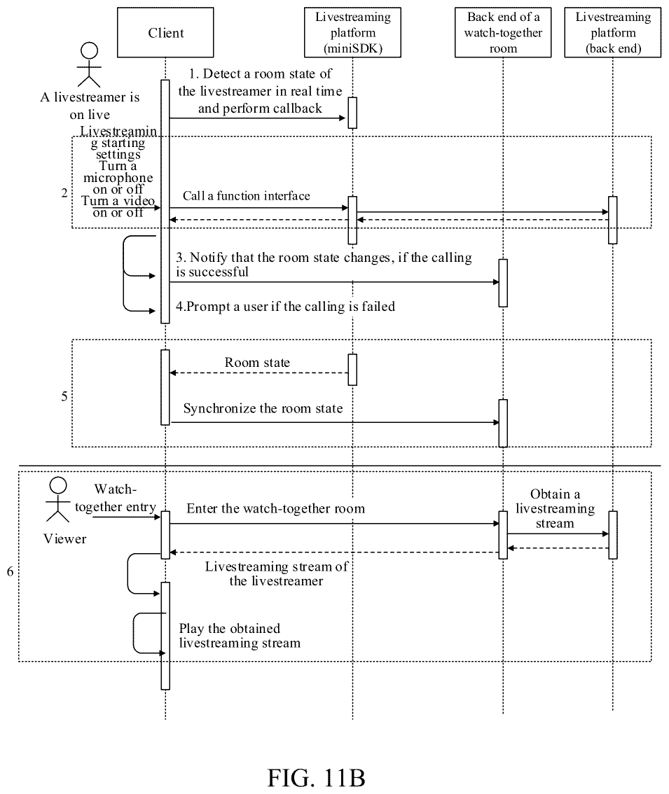

(2) A non-livestreaming object end views the livestreaming content of the livestreaming object. FIG. 11A is a schematic flowchart of a livestreaming processing method according to an embodiment of the present disclosure. The method includes the following: 1. The non-livestreaming object enters the watch-together room. 2. Pull information of the watch-together room and a livestreaming stream address from the back-end server. 3. Play a livestreaming stream based on the livestreaming stream address. 4. The back end of the livestreaming platform detects changes of a room state to update the room state of the room. FIG. 11B is a schematic flowchart of a livestreaming processing method according to an embodiment of the present disclosure. The method includes the following: 1. The livestreaming platform detects a room state of the livestreamer's in real time and performs callback. 2. The livestreamer performs operations such as settings for starting livestreaming, microphone settings, and video livestreaming settings on the client, and calls a corresponding function interface to synchronize setting information of the operations to the back end of the livestreaming platform. 3. If the function interface in operation 2 is successfully called, a back end of the watch-together room is notified that a room state of the room has changed, so that the back end of the watch-together room updates the room state of the room. 4. If calling of the function interface in operation 2 is failed, the user is to be prompted. 5. The client synchronizes the room state to the back end of the watch-together room. 6. When entering the room, the viewer obtains a livestreaming stream of the livestreamer from the back end of the livestreaming platform by using the back end of the watch-together room and plays the obtained livestreaming stream for viewing.

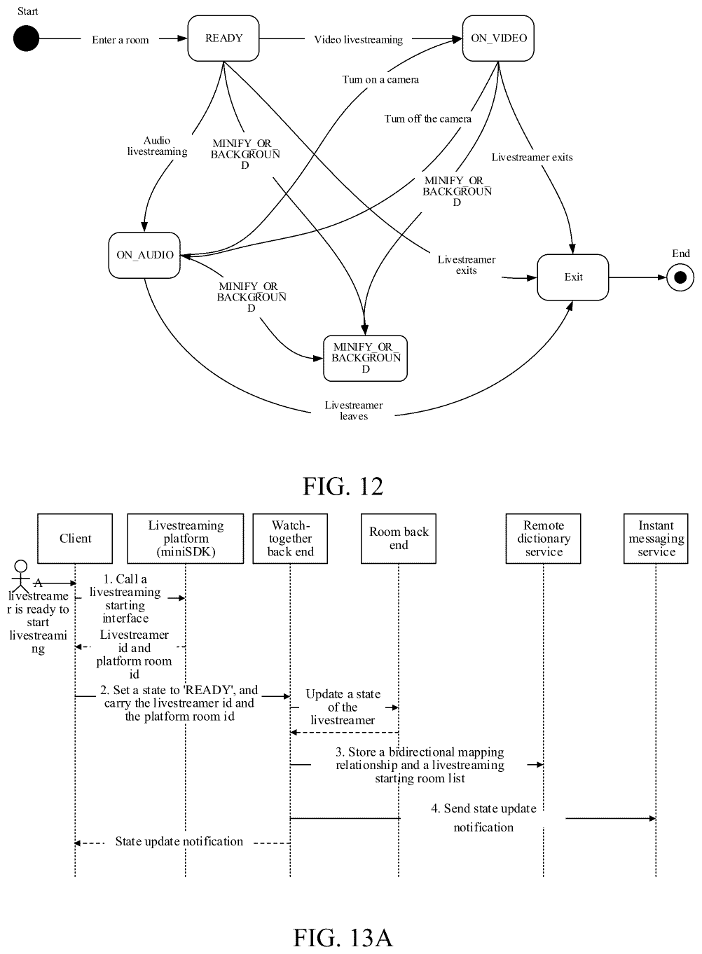

(3) Livestreaming state management. In the media sharing room, the livestreaming object may switch voice livestreaming and video livestreaming. In addition, the non-livestreaming object end also needs to obtain a livestreaming state of the livestreaming object, including states of the livestreaming object not entering the room, preparing, leaving, exiting, and the like. Different user interfaces (UIs) may be displayed based on different livestreaming states, and corresponding logic may be executed. The livestreaming end displays different states at different stages. FIG. 12 is a schematic diagram of synchronizing a livestreaming state according to an embodiment of the present disclosure. There are five livestreaming states: READY (ready for livestreaming), ON_VIDEO (on video livestreaming), ON_AUDIO (only on audio livestreaming), MINIFY_OR_BACKGROUND (back to background or minify), and EXIT. Switching between the livestreaming states is performed based on the events shown in FIG. 11. For example, when the video livestreaming is started, and the camera is turned on, the state is switched from ON_AUDIO to ON_VIDEO. When the audio livestreaming is started, and the camera is turned off, the state is switched from ON_VIDEO to ON_AUDIO.

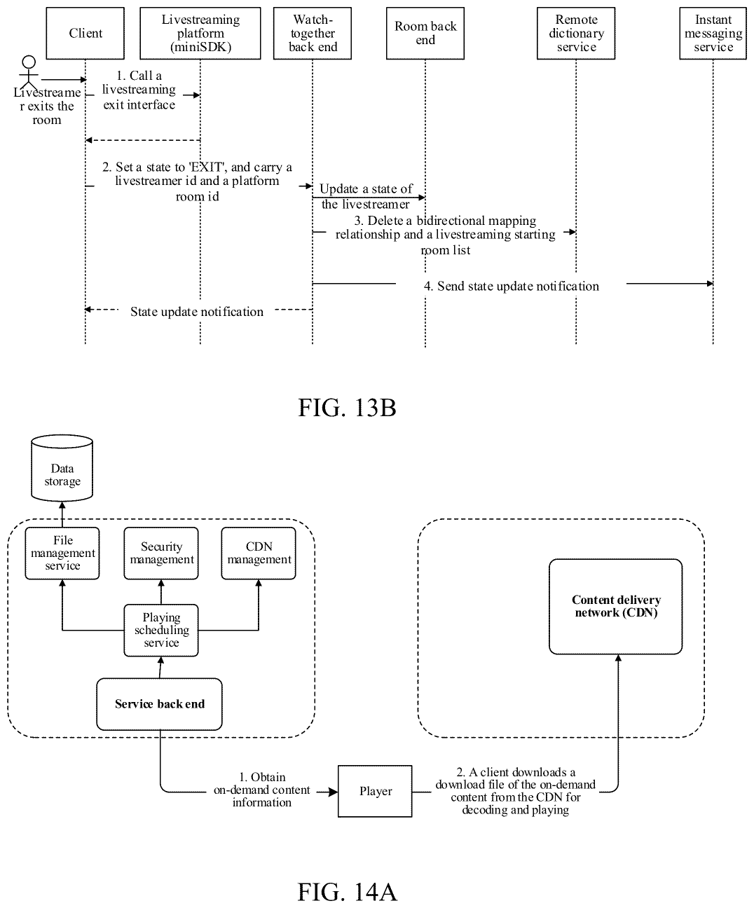

(3.1) State change-READY. When the client calls the livestreaming state and updates the state to READY, if the state updates successfully, the server further transmits an instant messaging (IM) notification message to the client. After receiving the IM notification message, the client actively pulls the room information to obtain the latest updated content. FIG. 13A is a schematic diagram of synchronizing a livestreaming state according to an embodiment of the present disclosure. The method includes the following: 1. The livestreamer is ready to start livestreaming, and a livestreaming starting interface of the livestreaming platform is called to obtain a livestreamer id and a platform room id of the livestreamer in the livestreaming platform; 2. Send a request carrying the livestreamer id and the platform id to the back-end server, and update the livestreamer status to READY. 3. The back-end server records a mapping relationship of “livestreamer id<->vuid” and a mapping relationship of “livestreaming platform room id<->watch-together room id”, and adds the room id to a livestreaming starting room set. 4. Send a state update notification message (where all users in the room join an IM group when entering the room) after information is successfully stored. All users who receive the state update notification message actively pulls the latest room information from the room back end.

(3.2) State change-EXIT. When the livestreaming state is updated to EXIT, the back-end server needs to delete previously recorded mapping relationships and then transmit a state update notification message to notify the client. Updates of other states are same as the above embodiments. A detailed process is as follows. FIG. 13B is a schematic diagram of synchronizing a livestreaming state according to an embodiment of the present disclosure. The process includes the following: 1. The livestreamer exits the room and calls a livestreaming exit interface of the livestreaming platform miniSDK to exit the livestreaming platform room. 2. Send a request carrying the livestreamer id and the platform id to a watch-together back end, and update the livestreamer status to EXIT. 3. The back-end server deletes the mapping relationship of “livestreamer id<->vuid” and the mapping relationship of “platform room id<->watch-together room id”, and removes the room id from the livestreaming starting room set. 4. Send a state update notification message (where all users in the room join an IM group when entering the room) after information is successfully stored. All users who receive the state update notification message actively pulls the latest room information from the room back end.

Playing of the livestreaming content and the media content in embodiments of the present disclosure is described. In this embodiment of the present disclosure, the room interface of the media sharing room includes an on-demand content region (a main playing region) and a livestreaming show-up region (a secondary playing region). (1) In the on-demand content region, the on-demand content (that is, the media content) played in the media playing window is not mixed with the livestreaming content stream, so that quality and resolution of an image are not be affected in any way, and the on-demand content has the same quality and resolution of an image as ordinary on-demand content. (2) In the livestreaming show-up region, one or more livestreaming players are added, and UIs are designed by the client. Livestreaming content streams played by the plurality of livestreaming players may freely choose to be mixed into one livestreaming stream (on-cloud stream mix in the show-up region) or a plurality of livestreaming streams (on-end stream mix in the show-up region) as needed. When the livestreaming content streams are mixed into a plurality of livestreaming streams, each livestreaming player may be zoomed in, zoomed out, dragged, and the like independently, and a position of the livestreaming player and a position of the media playing window may also be switched, to implement switching between the main playing region and the secondary playing region.

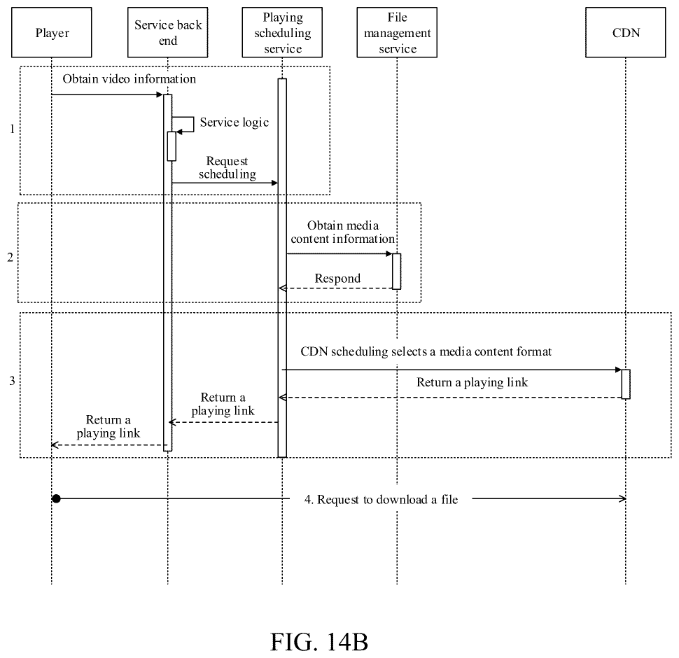

The following describes a playing process of the on-demand content in the on-demand content region. The on-demand content region is responsible for playing the on-demand content (that is, the media content), which is one of core functions of the video client. FIG. 14A is a schematic diagram of a structure of a playing system of media content according to an embodiment of the present disclosure. A client player interacts with two parties, that is, a service back end and a content delivery network (CDN). 1. The service back end provides on-demand content information, controls playing of the on-demand content based on a playing scheduling strategy and playback authentication information, and therefore belongs to a control path. 2. The CDN provides a download file for the on-demand content mainly for playing acceleration and fast buffering to improve playing experience, and therefore belongs to a data path. FIG. 14B is a schematic diagram of a playing process of media content according to an embodiment of the present disclosure. The process includes the following: 1. The client player requests the service back end to obtain media content information. 2. The service back end receives the player's request and requests a scheduling strategy service to request the media content information from a file management service. 3. The playing scheduling strategy service selects an appropriate media content format and requests a playing authentication service to perform playing authentication. After the authentication is passed, the service back end returns a CDN playing link to the client. 4. After obtaining the CDN playing link, the client player requests the CDN to pull the download file of the media content for decoding and playing.

The following describes a process of the on-end stream mix in the show-up region. In this embodiment of the present disclosure, in the livestreaming show-up region, one or more livestreaming players are added, and UIs are designed by the client. For a service scenario in which livestreaming content of each livestreaming object may be individually zoomed in, zoomed out, and dragged, each livestreaming object needs to correspond to one livestreaming content stream, so as to meet the scenario. In this case, a strategy of the on-end stream mix in the show-up region is used. The strategy of the on-end stream mix in the show-up region means that each livestreaming object has a separate show-up screen (the livestreaming content), and each livestreaming object corresponds to one livestreaming content stream. The client arranges livestreaming content of a plurality of livestreaming objects below the on-demand content for playing. Because the plurality of livestreaming streams needs to be played, compared with a strategy of the on-cloud stream mix in the show-up region, power consumption and heat generation on the client are more.

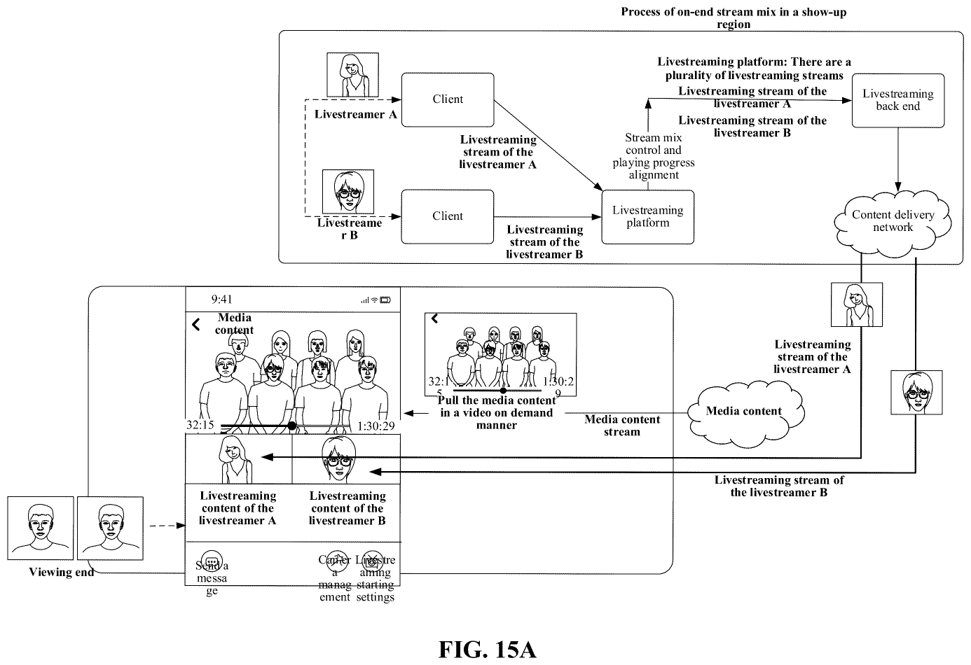

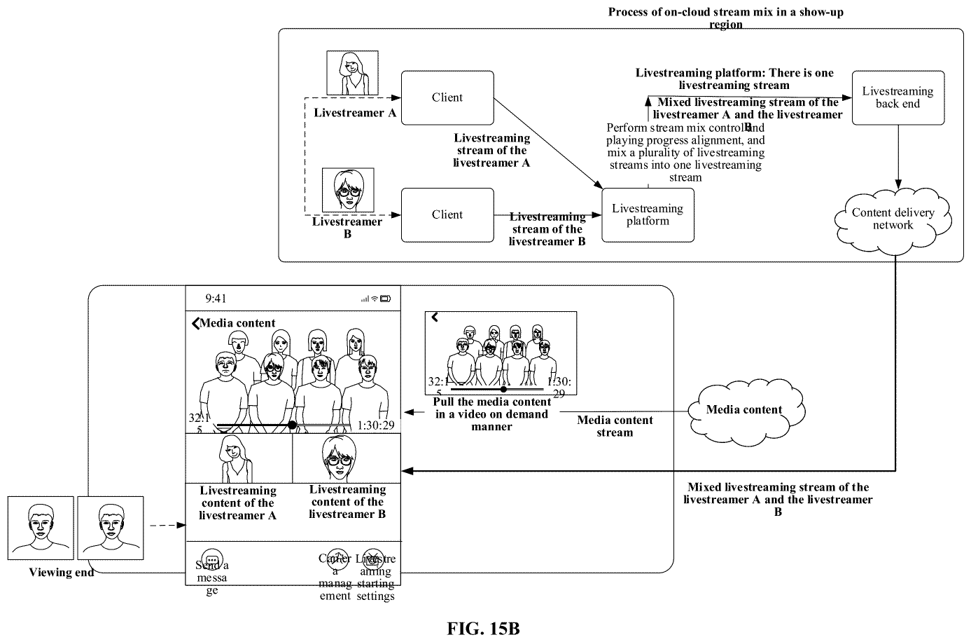

FIG. 15A is a schematic diagram of obtaining a livestreaming content stream and a media content stream according to an embodiment of the present disclosure. (1) The plurality of livestreaming objects start livestreaming on the client, and the livestreaming content streams of the livestreaming objects and the playing progress of the on-demand content are reported to the livestreaming platform. (2) The livestreaming platform performs stream mix control and playing progress alignment based on the reported livestreaming content streams and the on-demand content progress. The stream mix control is to mix the playing progress of the on-demand content into the livestreaming content streams. A quantity of the livestreaming content streams before and after the stream mix does not change. In other words, each livestreaming object corresponds to one livestreaming content stream. (3) The processing is completed by the livestreaming platform, to generate a plurality of livestreaming content streams, that is, the livestreaming content streams corresponding to livestreaming objects. (4) The client pulls an on-demand content stream and a livestreaming content stream of each livestreaming object for playing. In this way, because the on-demand content stream and each livestreaming content stream are independent of each other, a playing layout may be designed and controlled by the client. Each livestreaming player may be zoomed in, zoomed out, dragged, and the like independently, and a position of the livestreaming player and a position of the media playing window may also be switched, to implement switching between the main playing region and the secondary playing region.

The following describes a process of the on-cloud stream mix in the show-up region. In this embodiment of the present disclosure, in the livestreaming show-up region, one or more livestreaming players are added, and UIs are designed by the client. In a service scenario in which a requirement for zooming in, zooming out, and dragging a livestreaming screen individually is not high, but a requirement for client playing performance (such as strict requirements on power consumption and heat generation) is high, the livestreaming content streams of all the livestreaming objects may be mixed into one path for playing to reduce client hardware resource overheads. In this case, the strategy of the on-cloud stream mix in the show-up region needs to be used. The strategy of the on-cloud stream mix in the show-up region means that the livestreaming content streams of all the livestreaming objects are mixed into one livestreaming stream on the cloud. The client only needs to pull one livestreaming stream screen and arrange the livestreaming stream screen below the on-demand content for playing. Because only one livestreaming stream needs to be played, the power consumption and heat generation on the client can be controlled.

FIG. 15B is a schematic diagram of obtaining a livestreaming content stream and a media content stream according to an embodiment of the present disclosure. (1) The plurality of livestreaming objects start livestreaming on the client, and the livestreaming content streams of the livestreaming objects and the playing progress of the on-demand content are reported to the livestreaming platform. (2) The livestreaming platform performs stream mix control and playing progress alignment based on the reported livestreaming content streams and the on-demand content progress. The stream mix control is to mix the plurality of livestreaming content streams, output a livestreaming stream including the livestreaming content of all the livestreaming objects, and mix the playing progress of the on-demand content into the livestreaming stream. (3) After the livestreaming platform completes processing, a single livestreaming stream is generated, that is, a livestreaming stream including the livestreaming content of all the livestreaming objects. (4) The client pulls the on-demand content stream and one livestreaming stream for playing. In this way, when a requirement for zooming in, zooming out, and dragging the livestreaming screen individually is not high, the strategy of the on-cloud stream mix in the show-up region may be used to mitigate the power consumption and heat generation on the client.

In actual implementation, technical components or services used in this embodiment of the present disclosure mainly include the following. (1) Client includes iOS, Android, and a web page built with hypertext markup language 5.0 (HTML 5.0, H5) that collaborate with each other. (2) An authentication service is to authenticate whether a user has permission to play media content or livestreaming content. (3) Chatting/voice chatting/watching together is implemented based on instant messaging (IM) and real-time audio and video components. (4) Security review service is configured for reviewing legality of the livestreaming content. (5) Data storage is implemented by using MySQL, Redis, and the like. In actual applications, the technical components or services used in embodiments of the present disclosure may be replaced without affecting overall functionality. For example, a database may be another database product.

Based on the foregoing embodiments of the present disclosure, following technical effects can be implemented. (1) Product form innovation. A user can watch media content while interacting with a livestreaming object online and interacting with other users in a room simultaneously. (2) Image resolution and interactive flexibility. Combining video on demand and livestreaming technologies, video on demand is implemented on a media content region, resolving a problem that quality and resolution of an image of on-demand content is degraded because the video on demand is converted to livestreaming in a strategy of mixing a livestreaming stream and a video on demand stream, and the image resolution can be flexibly adjusted. Livestreaming is implemented on a show-up region. A plurality of livestreaming streams may be mixed on an end or on a cloud, and very flexible interaction can be implemented on a client, for example, a livestreaming screen may be zoomed in, zoomed out, or dragged, and a playing position of the livestreaming screen and a playing position of the media content may be switched. (3) Less engineering workload and easier implementation.

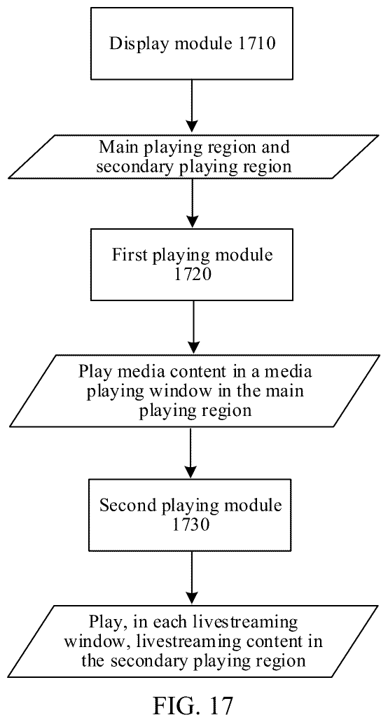

The following describes the livestreaming processing apparatus provided in this embodiment of the present disclosure. FIG. 17 is a schematic diagram of a structure of a livestreaming processing apparatus according to an embodiment of the present disclosure. The livestreaming processing apparatus also provided in this embodiment of the present disclosure includes: a display module 1710, configured to display a room interface of a media sharing room, the room interface including a main playing region and a secondary playing region, the secondary playing region including at least one livestreaming window, and each livestreaming window corresponding to a livestreaming object; a first playing module 1720, configured to play media content in a media playing window in the main playing region, the media content being configured for allowing at least two objects joining the media sharing room to view, and the at least two objects including the livestreaming object; and a second playing module 1730, configured to play, in each livestreaming window, livestreaming content of a livestreaming object corresponding to the livestreaming window in the secondary playing region.

In some embodiments, the first playing module 1720 is further configured to obtain a media content stream, and play the media content in the media playing window based on the media content stream. Correspondingly, the second playing module 1730 is further configured to: obtain a livestreaming content stream that is of each livestreaming object and that is independent of the media content stream, the livestreaming content streams being independent of each other; and play, in respect of each livestreaming window, in the livestreaming window based on a livestreaming content stream of a livestreaming object corresponding to the livestreaming window, livestreaming content of the livestreaming object corresponding to the livestreaming window.

In the foregoing solution, the apparatus further includes a position switch module. The position switch module is configured to: switch, in response to a position switching instruction for a target livestreaming window of the at least one livestreaming window, a position of the media playing window and a position of the target livestreaming window; and play, in the target livestreaming window, livestreaming content of a livestreaming object corresponding to the target livestreaming window in the main playing region, and play the media content in the media playing window in the secondary playing region.

In some embodiments, the secondary playing region includes at least one sub-playing region, the at least one livestreaming window is in one-to-one correspondence with the at least one sub-playing region, and a region size of the main playing region is larger than a region size of the sub-playing region. The position switch module is further configured to: adjust a window size of the media playing window, so that the window size of the media playing window matches a region size of a sub-playing region corresponding to the target livestreaming window; and adjust a window size of the target livestreaming window, so that the window size of the target livestreaming window matches the region size of the main playing region.

In some embodiments, the position switch module is further configured to: receive a first position switching instruction for a first livestreaming window, the first livestreaming window being a livestreaming window of the at least one livestreaming window that is different from the target livestreaming window; switch the position of the target livestreaming window and a position of the first livestreaming window in response to the first position switching instruction; play, in the first livestreaming window, livestreaming content of a livestreaming object corresponding to the first livestreaming window in the main playing region; and play, in the target livestreaming window, the livestreaming content of the livestreaming object corresponding to the target livestreaming window in the secondary playing region.

In some embodiments, the position switch module is further configured to: switch the position of the target livestreaming window and the position of the media playing window in response to a second position switching instruction for the media playing window; play again the media content in the media playing window in the main playing region; and play again, in the target livestreaming window, the livestreaming content of the livestreaming object corresponding to the target livestreaming window in the secondary playing region.

In some embodiments, the position switch module is further configured to: receive a trigger operation on the target livestreaming window of the at least one livestreaming window; and receive the position switching instruction for the target livestreaming window of the at least one livestreaming window in response to the trigger operation.

In some embodiments, the position switch module is further configured to: display, in response to a trigger operation on the target livestreaming window of the at least one livestreaming window, a position switching control corresponding to the target livestreaming window; and receive the position switching instruction for the target livestreaming window of the at least one livestreaming window in response to a trigger operation on the position switching control.

In some embodiments, the position switch module is further configured to: receive a drag operation on the target livestreaming window of the at least one livestreaming window; and receive the position switching instruction for the target livestreaming window of the at least one livestreaming window in response to the target livestreaming window being dragged to the main playing region.

In some embodiments, the second playing module 1730 is further configured to: receive a playing region moving-out instruction for the a second livestreaming window, the second livestreaming window being a livestreaming window of the at least one livestreaming window that is different from the target livestreaming window; and move the second livestreaming window out of the secondary playing region in response to the playing region moving-out instruction and control the second livestreaming window to be in a floating state.

In some embodiments, the second playing module 1730 is further configured to: move, after controlling the second livestreaming window to be in the floating state when a moving instruction for the second livestreaming window is received, the second livestreaming window in the floating state to a position indicated by the moving instruction; and adjust, when a window size adjustment instruction for the second livestreaming window is received, a window size of the second livestreaming window in the floating state to a target window size indicated by the window size adjustment instruction.

In some embodiments, the second playing module 1730 is further configured to: display a window restore control; control the second livestreaming window to exit the floating state and move to the secondary playing region in response to a trigger operation on the window restore control.

In some embodiments, the display module 1710 is further configured to: control a terminal to be in a vertical screen operation mode when a vertical screen operation instruction for the terminal is received, and use a first layout style, in the vertical screen operation mode, to display the room interface of the media sharing room; or control a terminal to be in a horizontal screen operation mode when a horizontal screen operation instruction for the terminal is received, and use a second layout style, in the horizontal screen operation mode, to display the room interface of the media sharing room. A position of a window in the room interface in the first layout style is different from that in the second layout style, and the window includes the media playing window and the livestreaming window.

In some embodiments, the display module 1710 is further configured to: display a window hiding control in the secondary playing region; display, in response to a trigger operation on the window hiding control, a selection control corresponding to each window in the secondary playing region, the window including at least one of the media playing window and the livestreaming window; and hide, in response to a trigger operation on a selection control corresponding to a target window of the windows, the target window in the secondary playing region.

In some embodiments, the display module 1710 is further configured to adjust, after hiding the target window in the secondary playing region, a window size of a remaining window in the secondary playing region so that the window size of the remaining window matches a region size of the secondary playing region. The remaining window is a window of the windows except the target window.

In some embodiments, the display module 1710 is further configured to: display a comment message window in a region that is in the room interface and that is independent of the main playing region and the secondary playing region, and display at least one comment message in the media sharing room in the comment message window; and display, when a trigger operation on a target comment message of the at least one comment message is received, an object details interface of a target object transmitting the target comment message.

In some embodiments, the display module 1710 is further configured to: display a livestreaming invitation control in the object details interface; and transmit a livestreaming invitation request to a terminal of the target object in response to a trigger operation on the livestreaming invitation control, the livestreaming invitation request being configured for inviting the target object to perform livestreaming in the media sharing room.

According to the foregoing embodiments of the present disclosure, a main playing region and a secondary playing region are displayed on a room interface of a media sharing room, the secondary playing region includes at least one livestreaming window, and each livestreaming window corresponds to a livestreaming object. In addition, media content is played in a media playing window in the main playing region, and livestreaming content of a corresponding livestreaming object is played in each livestreaming window in the secondary playing region. In this case, (1) the media sharing room may be for allowing at least two objects joining the media sharing room to view the media content played in the media playing window. The media sharing room may further for a livestreaming object of the at least two objects to perform livestreaming in the media sharing room. In this way, a user can perform livestreaming or watch livestreaming while viewing the media content, which increases functional diversity and experience diversity of the media sharing room and improves interactivity between users in the media sharing room and user stickiness, thereby fully utilizing hardware processing resources for creating and maintaining the media sharing room and improving utilization of the hardware processing resources. (2) The media content is played in the media playing window in the main playing region, and the livestreaming content of the corresponding livestreaming object is played in the livestreaming window in the secondary playing region, so that display content of each window is properly distributed and a display layout of each window is properly designed, thereby improving utilization of device display resources.

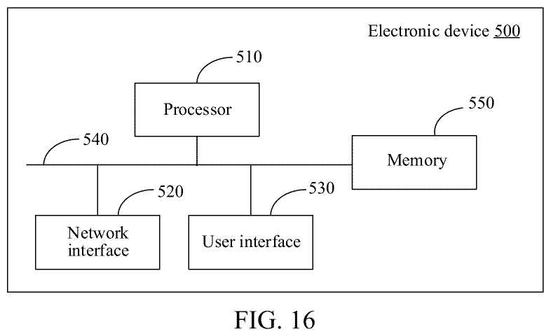

The following describes an electronic device for performing the livestreaming processing method provided in embodiments of the present disclosure. FIG. 16 is a schematic diagram of a structure of an electronic device 500 for performing a livestreaming processing method according to an embodiment of the present disclosure. The electronic device 500 may be a server or a terminal. An example in which the electronic device 500 is the terminal shown in FIG. 1 is used. The electronic device 500 for performing the livestreaming processing method provided in embodiments of the present disclosure includes at least one processor 510, a memory 550, at least one network interface 520, and a user interface 530. Components in the electronic device 500 are coupled together via a bus system 540. The bus system 540 is configured to implement connection and communication between the components. In addition to a data bus, the bus system 540 further includes a power bus, a control bus, and a status signal bus. However, for ease of clear description, various types of buses are marked as the bus system 540 in FIG. 16.

The processor 510 may be an integrated circuit chip with a signal processing capability, such as a general-purpose processor, a digital signal processor (DSP), or another programmable logic device, a discrete gate or a transistor logic device, or discrete hardware component. The general-purpose processor may be a microprocessor, any processor, or the like.

The memory 550 may be removable, non-removable, or a combination thereof. The memory 550 may include one or more storage devices physically away from the processor 510. The memory 550 includes a volatile memory or a non-volatile memory, or may include both a volatile memory and a non-volatile memory. The non-volatile memory may be a read-only memory (ROM), and the volatile memory may be a random access memory (RAM). The memory 550 described in this embodiment of the present disclosure is intended to include any suitable type of memories.

The memory 550 can store data to support various operations, and examples of the data include a program, a module, and a data structure, or a subset or superset thereof. In this embodiment of the present disclosure, the memory 550 has computer-executable instructions stored therein. When the computer-executable instructions are executed by the processor 510, the processor 510 is enabled to perform the livestreaming processing method provided in embodiments of the present disclosure.

An embodiment of the present disclosure further provides a computer program product. The computer program product includes computer-executable instructions. The computer-executable instructions are stored in a computer-readable storage medium. A processor of an electronic device reads the computer-executable instructions from the computer-readable storage medium. The processor executes the computer-executable instructions to enable the electronic device to perform the livestreaming processing method provided in embodiments of the present disclosure.

An embodiment of the present disclosure further provides a computer-readable storage medium, having computer-executable instructions stored thereon. The computer-executable instructions, when executed by a processor, causes the processor to perform the livestreaming processing method provided in embodiments of the present disclosure.

In some embodiments, the computer-readable storage medium may be a memory such as a ferroelectric random access memory (FRAM), a ROM, a programmable ROM (PROM), an electrically programmable ROM (EPROM), an electrically erasable programmable ROM (EEPROM), a flash memory, a magnetic surface memory, a compact disc, or a compact disc ROM (CD-ROM); or may be a variety of devices including one of the foregoing memories or any combination.

In some embodiments, the computer-executable instructions may be in the form of programs, software, software modules, scripts, or code, written in any form of programming language (which includes compiled or interpreted languages, or declarative or procedural languages), and may be deployed in any form, including being deployed to be executed independently or being deployed as a module, component, subroutine, or another unit suitable for use in a computing environment.

As an example, the computer-executable instructions may, but not necessarily, correspond to a file in a file system, and may be stored in a part of the file that stores other executable data, for example, stored in one or more scripts in a hyper text markup language (HTML) document, stored in a single file dedicated to the program under discussion, or stored in a plurality of collaborative files (for example, a file that stores one or more modules, sub-executable code sections).

As an example, the computer-executable instructions may be deployed to be executed on one electronic device or on a plurality of electronic devices located in one location, alternatively, on a plurality of electronic devices distributed in a plurality of locations and interconnected through communication networks.

The foregoing descriptions are merely embodiments of the present disclosure and are not intended to limit the protection scope of the present disclosure. Any modification, equivalent replacement, or improvement made without departing from the spirit and scope of the present disclosure shall fall within the protection scope of the present disclosure.

What is claimed is:

1. A livestreaming processing method, performed by an electronic device, and comprising:
displaying a room interface of a media sharing room, the room interface comprising a main playing region and a secondary playing region, the secondary playing region comprising at least one livestreaming window, and each livestreaming window corresponding to a livestreaming object;
playing media content in a media playing window in the main playing region, the media content being viewable by at least two objects joining the media sharing room, and the at least two objects comprising the livestreaming object; and
playing, in the at least one livestreaming window, livestreaming content of at least one livestreaming object corresponding to the at least one livestreaming window in the secondary playing region.

2. The method according to claim 1, wherein a position of a livestreaming window of the at least one livestreaming window is interchangeable with a position of the media playing window.

3. The method according to claim 1, wherein the playing media content in a media playing window comprises:
obtaining a media content stream, and playing the media content in the media playing window based on the media content stream; and
the playing, in each the at least one livestreaming window, livestreaming content of at least one livestreaming object corresponding to the at least one livestreaming window comprises:
obtaining a livestreaming content stream that is of each livestreaming object and that is independent of the media content stream, the livestreaming content streams being independent of each other; and
playing, in the livestreaming window based on a livestreaming content stream of a livestreaming object corresponding to the livestreaming window, livestreaming content of the livestreaming object corresponding to the livestreaming window.

4. The method according to claim 1, further comprising:
switching, in response to a position switching instruction for a target livestreaming window of the at least one livestreaming window, a position of the media playing window and a position of the target livestreaming window; and
playing, in the target livestreaming window, livestreaming content of a livestreaming object corresponding to the target livestreaming window in the main playing region, and playing the media content in the media playing window in the secondary playing region.

5. The method according to claim 4, wherein the secondary playing region comprises at least one sub-playing region, the at least one livestreaming window is in one-to-one correspondence with the at least one sub-playing region, and a region size of the main playing region is larger than a region size of a sub-playing region; and
after the switching a position of the media playing window and a position of the target livestreaming window, the method further comprises:
adjusting a window size of the media playing window to match a region size of a target sub-playing region corresponding to the target livestreaming window; and
adjusting a window size of the target livestreaming window to match the region size of the main playing region.

6. The method according to claim 4, further comprising:
receiving a first position switching instruction for a first livestreaming window, the first livestreaming window being a livestreaming window of the at least one livestreaming window that is different from the target livestreaming window;
switching the position of the target livestreaming window and a position of the first livestreaming window in response to the first position switching instruction;
playing, in the first livestreaming window, livestreaming content of a livestreaming object corresponding to the first livestreaming window in the main playing region; and
playing, in the target livestreaming window, the livestreaming content of the livestreaming object corresponding to the target livestreaming window in the secondary playing region.

7. The method according to claim 4, further comprising:
switching the position of the target livestreaming window and the position of the media playing window in response to a second position switching instruction for the media playing window;
playing again the media content in the media playing window in the main playing region; and
playing again, in the target livestreaming window, the livestreaming content of the livestreaming object corresponding to the target livestreaming window in the secondary playing region.

8. The method according to claim 4, further comprising:
receiving a trigger operation on the target livestreaming window of the at least one livestreaming window; and
receiving the position switching instruction for the target livestreaming window of the at least one livestreaming window in response to the trigger operation.

9. The method according to claim 4, further comprising:
displaying, in response to a trigger operation on the target livestreaming window of the at least one livestreaming window, a position switching control corresponding to the target livestreaming window; and
receiving the position switching instruction for the target livestreaming window of the at least one livestreaming window in response to a trigger operation on the position switching control.

10. The method according to claim 4, further comprising:
receiving a drag operation on the target livestreaming window of the at least one livestreaming window; and
receiving the position switching instruction for the target livestreaming window of the at least one livestreaming window in response to the target livestreaming window being dragged to the main playing region.

11. The method according to claim 4, further comprising:
receiving a playing region moving-out instruction for a second livestreaming window, the second livestreaming window being a livestreaming window of the at least one livestreaming window that is different from the target livestreaming window; and
moving the second livestreaming window out of the secondary playing region in response to the playing region moving-out instruction and controlling the second livestreaming window to be in a floating state.

12. The method according to claim 11, wherein the method further comprises:
moving, upon receiving a moving instruction for the second livestreaming window, the second livestreaming window in the floating state to a position indicated by the moving instruction; and
adjusting, when a window size adjustment instruction for the second livestreaming window is received, a window size of the second livestreaming window in the floating state to a target window size indicated by the window size adjustment instruction.

13. The method according to claim 11, further comprising:
displaying a window restore control; and
controlling the second livestreaming window to exit the floating state and move to the secondary playing region in response to a trigger operation on the window restore control.

14. The method according to claim 1, wherein the displaying a room interface of a media sharing room comprises:
controlling a terminal to be in a vertical screen operation mode when a vertical screen operation instruction for the terminal is received, and using a first layout style, in the vertical screen operation mode, to display the room interface of the media sharing room; or
controlling a terminal to be in a horizontal screen operation mode when a horizontal screen operation instruction for the terminal is received, and using a second layout style, in the horizontal screen operation mode, to display the room interface of the media sharing room,
a position of a window in the room interface in the first layout style being different from that in the second layout style, and the window comprising the media playing window and the livestreaming window.

15. The method according to claim 1, further comprising:
displaying a window hiding control in the secondary playing region;
displaying, in response to a trigger operation on the window hiding control, a selection control corresponding to each window in the secondary playing region, the window comprising at least one of the at least one livestreaming window or the media playing window; and
hiding, in response to a trigger operation on a selection control corresponding to a target window of the windows, the target window in the secondary playing region.

16. The method according to claim 15, wherein the method further comprises:
adjusting a window size of a remaining window in the secondary playing region to match a region size of the secondary playing region,
the remaining window being a window of the windows except the target window.

17. The method according to claim 1, further comprising:
displaying a comment message window in a region that is in the room interface and that is independent of the main playing region and the secondary playing region, and displaying at least one comment message in the media sharing room in the comment message window; and
displaying, when a trigger operation on a target comment message of the at least one comment message is received, an object details interface of a target object transmitting the target comment message.

18. The method according to claim 17, further comprising:
displaying a livestreaming invitation control in the object details interface; and
transmitting a livestreaming invitation request to a terminal of the target object in response to a trigger operation on the livestreaming invitation control, the livestreaming invitation request being configured for inviting the target object to perform livestreaming in the media sharing room.

19. A livestreaming processing apparatus, comprising:
at least one memory, configured to store computer-executable instructions; and
at least one processor, configured to, when executing the computer-executable instructions stored in the at least one memory, implement:
displaying a room interface of a media sharing room, the room interface comprising a main playing region and a secondary playing region, the secondary playing region comprising at least one livestreaming window, and each livestreaming window corresponding to a livestreaming object;
playing media content in a media playing window in the main playing region, the media content being viewable by at least two objects joining the media sharing room, and the at least two objects comprising the livestreaming object; and
playing, in the at least one livestreaming window, livestreaming content of at least one livestreaming object corresponding to the at least one livestreaming window in the secondary playing region.

20. A non-transitory computer-readable storage medium, having computer-executable instructions stored thereon, the computer-executable instructions, when executed by at least one processor, causing the at least one processor to perform:
displaying a room interface of a media sharing room, the room interface comprising a main playing region and a secondary playing region, the secondary playing region comprising at least one livestreaming window, and each livestreaming window corresponding to a livestreaming object;
playing media content in a media playing window in the main playing region, the media content being viewable by at least two objects joining the media sharing room, and the at least two objects comprising the livestreaming object; and
playing, in the at least one livestreaming window, livestreaming content of at least one livestreaming object corresponding to the at least one livestreaming window in the secondary playing region.
